(19) United States
(12) Patent Application Publication
(10) Pub. No.: US 2022/0364848 A1
(43) Pub. Date: Nov. 17, 2022

(54) DEPTH MEASUREMENT APPARATUS AND DEPTH MEASUREMENT METHOD

(71) Applicant: Industrial Technology Research Institute, Hsinchu (TW)

(72) Inventors: Ludovic Angot, Hsinchu City (TW); Ching-Han Yang, Changhua County (TW)

(73) Assignee: Industrial Technology Research Institute, Hsinchu (TW)

(21) Appl. No.: 17/319,107

(22) Filed: May 13, 2021

(51) Int. Cl. G01B 11/22; G02B 27/30; G02B 5/00; G02B 27/28; G02B 27/09

(52) U.S. Cl. CPC G01B 11/22; G02B 27/30; G02B 5/001; G02B 27/283; G02B 27/0988; G01B 2210/56

(57) ABSTRACT

A depth measurement apparatus including an illumination module, a beam splitter, an objective lens, an image capture module, a controller and a processor is provided. The illumination module is configured to generate an illumination beam. The beam splitter and the objective lens are disposed on an optical path of the illumination beam, and the object lens is configured to focus the illumination beam into a hole formed in an object. The image capture module is configured to capture images of the hole at different heights. The controller is coupled to the illumination module and the image capture module. The processor is coupled to the controller and the image capture module, and configured to perform focus distance evaluations on the images captured by the image capture module to obtain a height difference between two surfaces of the object. A depth measurement method is also provided.

### TECHNICAL FIELD

The disclosure relates to a depth measurement apparatus and a depth measurement method.

### BACKGROUND

The continuous development of electronic, computation and communication equipment has driven semiconductor packages and components miniaturization towards integrating more features and functionalities into smaller Printed Circuit Board (PCB) footprints. This has led to the development of technologies such as High Density Interconnect (HDI) PCBs where several layers of conductive material are interconnected with each other using metallized holes called via. Depending on design requirements, the diameter of vias may range between 50 μm to 500 μm and their depth between 20 μm to 6 mm. Aspect ratios (AR), also known as height to width ratio (HWR), of the vias are therefore between 2:1 and 40:1. Besides the metallized vias, there also exists through vias, back drilled vias, and other types of vias that will be referred to in this disclosure simply as blind hole and through hole. The depth of these holes is required to be known with high accuracy and it may also be required to measure the diameter or inspect the bottom of the hole. But when the aspect ratio of the hole increases and its diameter decreases, the bottom area of the hole cannot be properly illuminated with traditional illumination approaches, one of them being a Gaussian beam generated using standard focusing techniques. Indeed, the Depth Of Focus (DOF) of Gaussian beams generated using standard focusing techniques may not be large enough to reach the bottom of the hole. Attempts to use high irradiance extended light sources common in machine visions inspection systems results in a low contrast images of the bottom surfaces of the holes; in addition, the top surface receiving a much larger amount of light compared to the bottom, the dynamic range of the sensor may not be sufficient to provide a proper image of the bottom of the hole. Since clear images of the hole bottom surface could not be obtained, focus variation or depth from focus/defocus approaches could not be used to obtain the depth of the hole, the bottom surface of the hole could not be inspected and the diameter of the bottom of the hole could not be measured. This makes it difficult for manufacturers of such HDI PCB to ensure a high product quality. Hence, there is a need to provide an approach for measuring the depth of high aspect ratio and narrow diameter holes and to provide an image of a bottom surface of vias.

### SUMMARY

A depth measurement apparatus of the disclosure includes an illumination module, a beam splitter, an image capture module, a controller and a processor. The illumination module includes a light source, a collimating assembly and a beam shaping optical assembly, and is configured to generate an illumination beam. The beam splitter is disposed on an optical path of the illumination beam. The objective lens is disposed on the optical path of the illumination beam and configured to focus the illumination beam into a hole formed in an object. The image capture module includes the objective lens, a tube lens, a tunable lens assembly and an image sensor, and is configured to capture images of the hole at different heights. The controller is coupled to the illumination module and the image capture module, wherein the controller is configured to control the illumination module and the image capture module. The processor is coupled to the controller and the image capture module, and is configured to perform focus distance evaluations on the images captured by the image capture module in order to obtain a height difference between two surfaces of the object.

A depth measurement method of the disclosure uses the depth measurement apparatus described above. The depth measurement method of the disclosure includes steps as follows. Setting a first working distance at an initial position at a vicinity of a first surface of a hole formed in an object. Performing a first local scan on the hole with a first focusing range starting from the first working distance. Performing a first focus distance evaluation to obtain a first distance shift from the initial position. Obtaining a height from the first surface of the hole to the initial position. Setting a second working distance at a position with an expected height from the initial position by using a relative translation. Performing a second local scan on the hole with a second focusing range starting from a start distance with an interval distance away from the second working distance. Performing a second focus distance evaluation to obtain a second distance shift from the start distance. Obtaining a height from a second surface of the hole to the initial position. Calculating a height difference between the height from the second surface and the height from the first surface of the hole to the initial position so as to obtain an actual depth of the hole.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating a depth measurement apparatus according to an exemplary embodiment of the disclosure.

FIG. 2 is a schematic diagram of an optical system on a translation stage of FIG. 1.

FIG. 3A illustrates a high aspect ratio through hole being illuminated by an illumination beam according to an exemplary embodiment of the disclosure.

FIG. 3B illustrates a high aspect ratio blind hole being illuminated by an illumination beam according to an exemplary embodiment of the disclosure.

FIG. 4 is a schematic diagram illustrating a dimensional relationship between the high aspect ratio hole of FIG. 3A or FIG. 3B and the illumination beam incident thereon.

FIG. 5A to FIG. 5C, FIG. 6A and FIG. 7 are schematic diagrams of illumination modules that could be used in exemplary embodiments of the disclosure.

FIG. 6B is a schematic plan view illustrating an annular slit of an aperture filter of FIG. 6A according to an exemplary embodiment of the disclosure.

FIG. 8 is a graph illustrating a relationship between a working distance of an objective lens and a diameter of the illumination beam according to an exemplary embodiment of the disclosure.

FIG. 9 is a schematic diagram of an image capture module that could be used in an exemplary embodiment of the disclosure.

FIG. 10 is a graph illustrating a relationship between an electrical parameter applied and a focus distance of the image capture module of FIG. 9 according to an exemplary embodiment of the disclosure.

FIG. 11 is a flow chart of a depth measurement method according to an exemplary embodiment of the disclosure.

FIG. 12 is a schematic diagram showing steps for measuring a depth of a high aspect ratio hole according to an exemplary implementation of the depth measurement method.

### DETAILED DESCRIPTION OF DISCLOSED EMBODIMENTS

A depth measurement apparatus of the disclosure is configured to measure a depth of a hole formed in an object. Specifically, the depth measurement apparatus of the disclosure is configured to measure the depth of a hole with a high aspect ratio (height to width ratio; HWR), by generating an illumination beam capable of illuminating the bottom of the hole and by performing a focus distance evaluation.

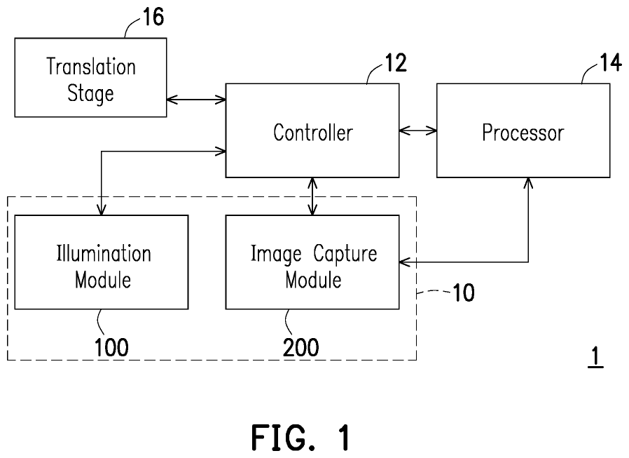

FIG. 1 is a block diagram illustrating a depth measurement apparatus according to an exemplary embodiment of the disclosure. The depth measurement apparatus 1 includes an optical system 10, a controller 12, a processor 14, and a translation stage 16. The controller 12 is coupled to the optical system 10 and the translation stage 16 to control operations of the optical system 10 and movements of the translation stage 16, wherein the optical system 10 includes an illumination module 100 and an image capture module 200 both coupled to the controller 12, and the image capture module 200 is positioned above the translation stage 16. The processor 14 is coupled to the controller 12 and the image capture module 200, wherein the processor 14 performs calibration of the image capture module 200, performs image processing operations and performs focus distance evaluations on images captured by the image capture module 200. Details regarding the calibration, the image processing operations and the focus distance evaluations will be described later.

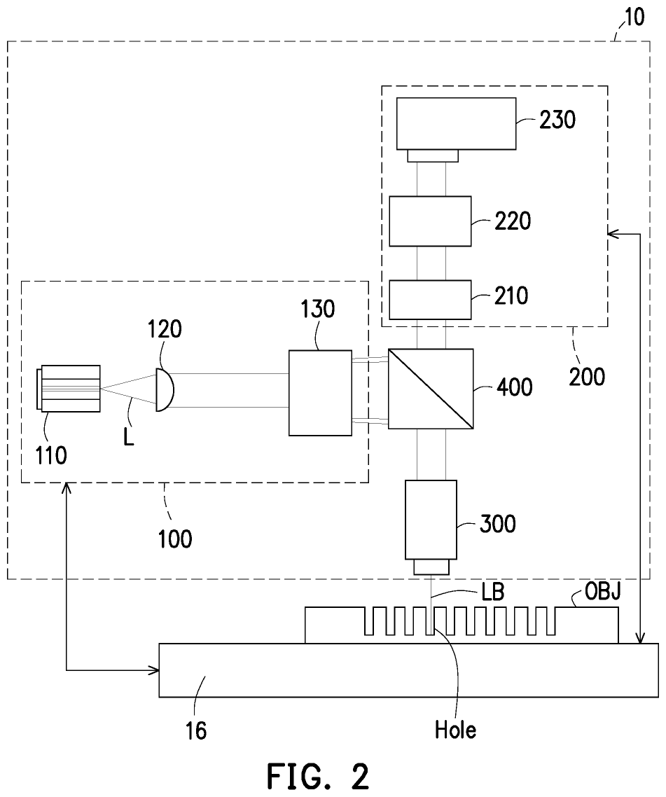

FIG. 2 is a schematic diagram of an optical system on a translation stage of FIG. 1. The illumination module 100 of the embodiment includes a light source 110, a collimating assembly 120 and a beam shaping optical assembly 130. The light source 110 may be a coherent, incoherent or partially coherent light source, and the light source may include at least one light emitting element. For example, the light source 110 includes at least one laser diode, one superluminescent diode, one light emitting diode (LED), or a combination thereof. The light source 110 is configured to generate a light beam L. The light beam L may, for example, be a Gaussian beam. The collimating assembly 120 is disposed on a transmission path of the light beam L emitted from the light source 110, and is located between the light source 110 and the beam shaping optical assembly 130. Non-point source and incoherent light source such as a LED may not produce a properly collimated beam, and thus light from such source could first pass through a small aperture such as a pinhole prior to collimation by the collimating assembly 120.

In the embodiment, as shown in FIG. 2, the collimating assembly 120 includes at least one optical lens to collimate the light beam L from the light source 110 and transmit the collimated light beam to the beam shaping optical assembly 130. The light beam L from the light source 110 is transmitted to the beam shaping optical assembly 130 after passing through the collimating assembly 120. The beam shaping optical assembly 130 is disposed on the transmission path of the light beam L, and is configured to convert and shape the light beam L so that it becomes a non-diffracting beam after passing through the objective lens 300. The beam then has a high aspect ratio with a narrow diameter, which is for example 50 μm, 200 μm or 500 μm, and a correspondingly long depth of field (DOF), which is for example 200 μm, 1 mm or 5 mm respectively. Some particular beams responding to these characteristics are called Bessel beams, but other suitable types of beam are vector beams. The beam shaping optical assembly 130 is further configured to generate an illumination beam LB, whose largest dimension is smaller than or equal to the smallest dimension of a hole to be measured over the depth of the hole to be measured, from the light beam L. In the following embodiments of the disclosure, the illumination beam LB is a Bessel beam but the disclosure is not limited thereto.

Referring to FIG. 2, the illumination beam LB is, for example, used to illuminate blind holes formed in an object OBJ so as to measure a depth of the hole. The object OBJ may, for example, be a multilayer printed circuit board (PCB) or a wafer, and the object OBJ may include more than one hole.

In addition to the illumination module 100 and the image capture module 200, the optical system 10 further includes an objective lens 300, and may also include a beam splitter 400. In the configuration of FIG. 2, the objective lens 300 is disposed on a transmission path of the illumination beam LB, and is disposed between the illumination module 100 and the object OBJ, and in one embodiment, between the beam shaping optical assembly 130 and the object OBJ. The objective lens 300 may be an infinite conjugate objective lens including a plurality of optical elements. In the configuration of FIG. 2, the beam splitter 400 is disposed on the transmission path of the illumination beam LB, and is disposed between the illumination module 100 and the object OBJ and between the image capture module 200 and the object OBJ. The beam splitter 400 may be a polarizing beam splitter and a quarter wave plate may be positioned between the objective lens and the polarizing beam splitter so as to allow a polarization analysis of the object or to contribute to eliminating unwanted reflections. In the embodiment, the beam splitter 400 is configured to partially reflect a light beam from the illumination module 100 towards the objective lens 300 and allow a light beam from the objective lens 300 to pass through to be transmitted to the image capture module 200. It could be noted that a positional relationship between the illumination module 100, the image capture module 200, the objective lens 300, and the beam splitter 400 within the optical system 10 is not limited to the setup shown in FIG. 2.

In the embodiment, the image capture module 200 includes a tube lens 210, a tunable lens assembly 220 and an image sensor 230. Referring to FIG. 2, the tube lens 210 is disposed between the objective lens 300 and the tunable lens assembly 220, and in one embodiment, between the beam splitter 400 and the tunable lens assembly 220. The tube lens 210 may include more than one optical element. The tunable lens assembly 220 is disposed between the tube lens 210 and the image sensor 230, and the tube lens 210, the tunable lens assembly 220 and the image sensor 230 are sequentially disposed on a transmission path of a light beam transmitted from the objective lens 300.

In the embodiment, the object OBJ is, for example, disposed on the translation stage 16 (not shown), and is positioned at a proper working distance from the image capture module 200. The translation stage 16 is configured to position the hole to be measured under the illumination beam LB, and is able to change a distance between the object OBJ and the objective lens 300. The translation stage 16 may be a mechanical translation stage capable of performing translation movements in X, Y and Z directions, but the disclosure is not limited thereto.

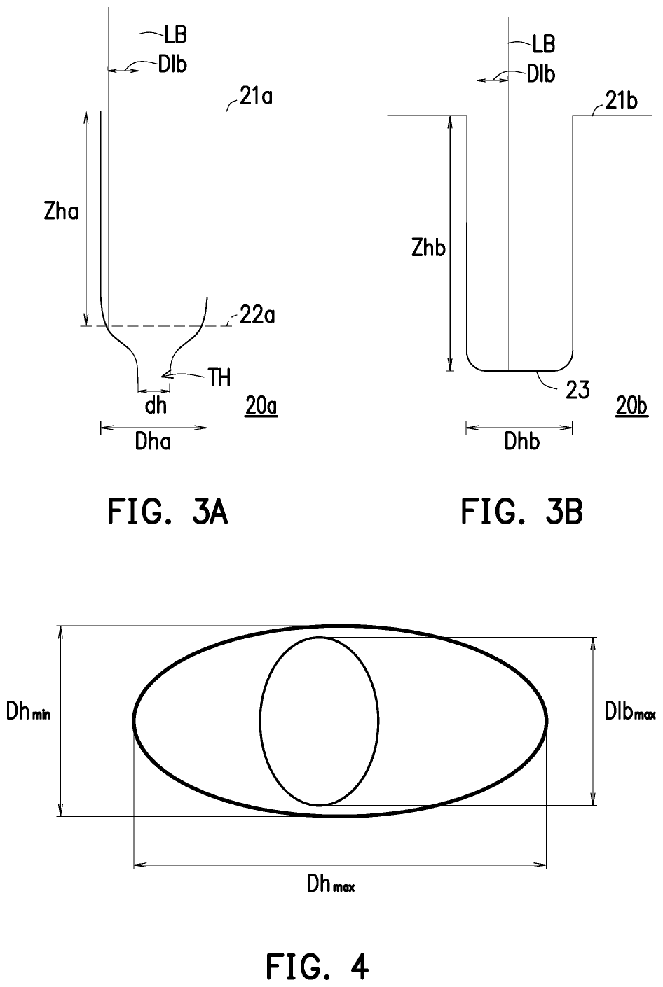

FIG. 3A and 3B illustrate two possible configurations of vias commonly encountered in High Density Integration (HDI) PCB. FIG. 3A illustrates a high aspect ratio through hole being illuminated by an illumination beam according to an exemplary embodiment of the disclosure. A first section of the hole has a height of Zha from the top surface 21a of the object 20a to an intermediate layer 22a of the object 20a, and a diameter Dha while a second section of the hole has a smaller diameter of dh. The illumination beam has a diameter Dlb and a DOF at least equal to Zha. FIG. 3B illustrates a high aspect ratio blind hole being illuminated by an illumination beam according to an exemplary embodiment of the disclosure. The blind hole has a depth Zhb measured from the top surface 21b of the object 20b to the bottom surface 23 of the hole, and a diameter Dhb. The illumination beam has a diameter Dlb and a DOF at least equal to Zhb. The configurations of the holes to be inspected or measured by the depth measurement apparatus 1 are not limited to the holes shown in the embodiments illustrated by FIG. 3A and FIG. 3B.

FIG. 4 is a schematic diagram illustrating a dimensional relationship between the high aspect ratio hole of FIG. 3A or FIG. 3B and the illumination beam incident thereon. Referring to FIG. 4 and either one of FIG. 3A or FIG. 3B illumination beam LB generated by the illumination module 100 is characterized by having a diameter Dlb smaller than a diameter Dha or Dhb of the hole to be measured so that the illumination beam LB may not illuminate the top surface 21a of object 20a or the top surface 21b of the object 20b. In one embodiment, a maximum diameter Dlbₘₐₓ of the illumination beam LB is, for example, smaller than or equal to the smallest dimension of the hole (i.e., a minimum diameter Dhₘᵢₙ of the hole) over the depth of the hole. Details on how the illumination beam LB could be generated with the above-mentioned characteristics in order to illuminate the bottom of a high aspect ratio hole will be described in the following sections.

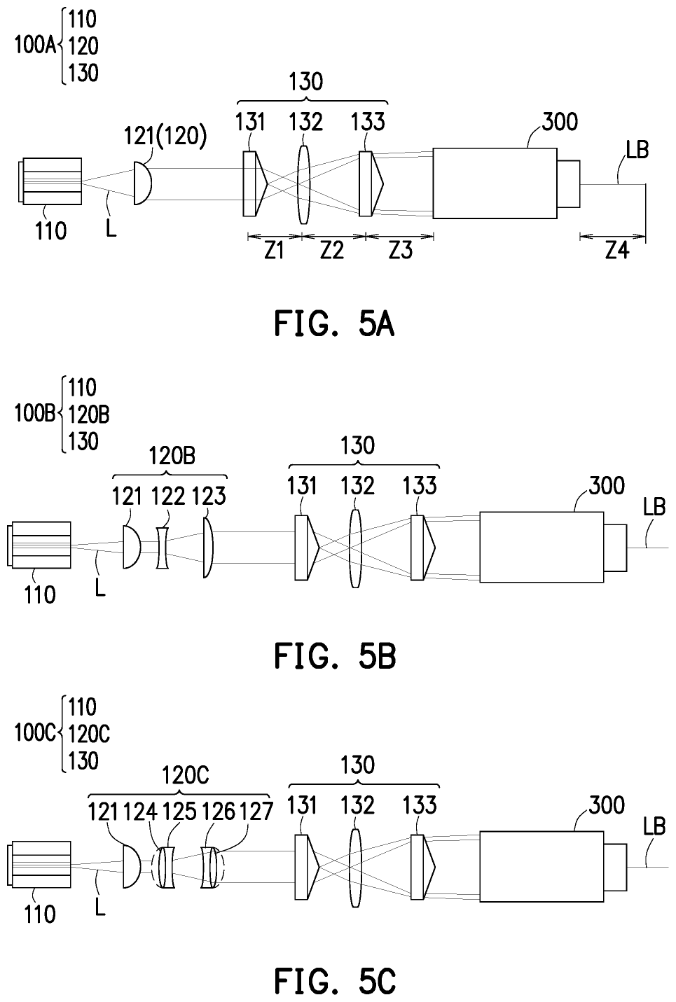

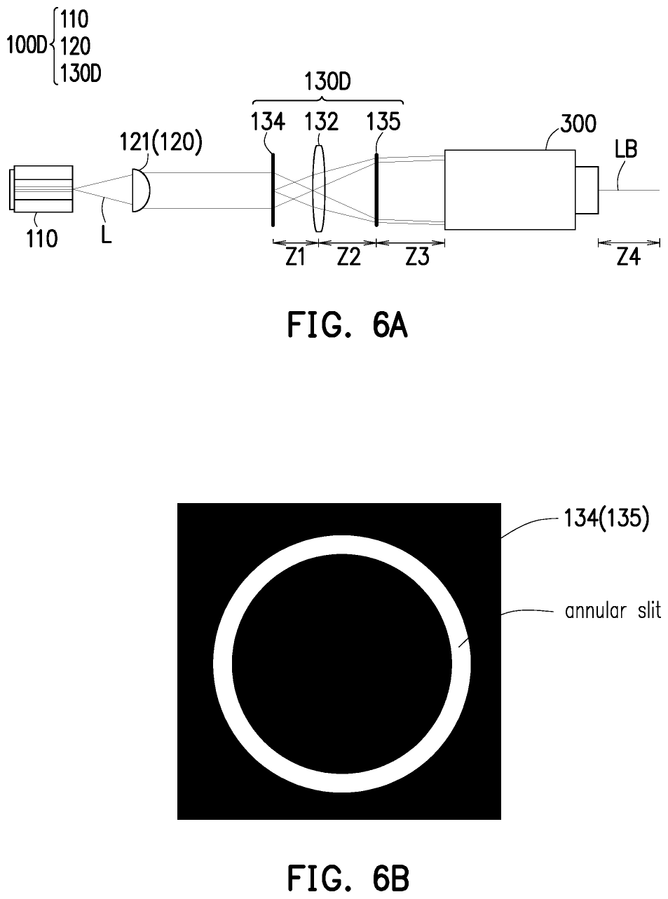

FIG. 5A to FIG. 5C, FIG. 6A and FIG. 7 are schematic diagrams of illumination modules that could be used in exemplary embodiments of the disclosure. For the convenience of explanation and without altering the scope of the disclosure, components relevant to the generation of the illumination beam LB (that is, components on an illumination path of the optical system 10) are illustrated in FIG. 5A to FIG. 5C, FIG. 6A and FIG. 7 without the beam splitter 400. Indeed, the beam splitter 400 only contributes to light absorption or light polarization of the illumination beam and does not alter the diameter and depth of focus of the illumination beam.

A configuration of an illumination module 100A according to an exemplary embodiment (e.g., a first embodiment of the illumination module) of the disclosure will now be described with reference to FIG. 5A. The light source 110, the collimating assembly 120, the beam shaping optical assembly 130, and the objective lens 300 are sequentially disposed on an illumination path of the optical system 10. In the embodiment, the collimating assembly 120 includes a collimating lens 121, and the beam shaping optical assembly 130 may include a first axicon 131, a relay lens 132 and a second axicon 133, wherein the relay lens 132 may be a plano convex or bi-convex lens and is disposed between the first axicon 131 and the second axicon 133. The first axicon 131 and the second axicon 133 in the embodiment are, for example, axicons with a physical angle of 0.5 to 5 degrees. In one embodiment, the relay lens 132 may be replaced by an electrical tunable focus lens which is electrically coupled to the controller 12. Moreover, a relative distance between the first axicon 131 and the relay lens 132 is noted z1, a relative distance between the relay lens 132 and the second axicon 133 is noted z2, a relative distance between the second axicon 133 and the back focal plane of the objective lens 300 is noted z3, and a focal length of the objective lens 300 is defined as z4. It is to be noted that the diameter Dlb of the illumination beam

LB depends on the relative distances z1, z2 and z3, as well as the focal length z4 of the objective lens 300 and the diameter of the input light beam L generated by the light source 110, wherein varying the relative distances z1 and z2 between the first axicon 131, the relay lens 132 and the second axicon 133 may vary the shape of the illumination beam LB, and varying the relative distance z3 between the second axicon 133 and the back focal plane of the objective lens 300 may further vary a working distance of illuminating beam through the objective lens 300. In other words, by varying any one or more of the parameters mentioned above (i.e., z1, z2, z3, z4, and a diameter of the input light beam L), the illumination beam LB could be adjusted to suit the diameter and depth of the hole to be inspected.

A configuration of an illumination module 100B according to an exemplary embodiment (e.g., a second embodiment of the illumination module) of the disclosure will now be described with reference to FIG. 5B. The configuration of the illumination module 100B in FIG. 5B is similar to the configuration of the illumination module 100A in FIG. 5A, and a main difference therebetween is that a collimating assembly 120B of the illumination module 100B further includes a diverging lens 122 and a converging lens 123 in addition to the collimating lens 121. The diverging lens 122 and the converging lens 123 may, for example, constitute a Galilean beam expander. In the embodiment shown in FIG. 5B, the relative distances z1, z2 and z3 between the first axicon 131, the relay lens 132, the second axicon 133, and the back focal plane of the objective lens 300 may remain the same as in the embodiment shown in FIG. 5A, and the addition of the Galilean beam expander is mainly for adjusting the diameter of the light beam L. It could be noted that different types of beam expanders, such as a Keplerian beam expander or a zoom beam expander, as well as a beam reducer, could be used in place of the above described and illustrated Galilean beam expander, and so without changing the spirit of the present embodiment.

A configuration of an illumination module 100C according to an exemplary embodiment (e.g., a third embodiment of the illumination module) of the disclosure will now be described with reference to FIG. 5C. The configuration of the illumination module 100C in FIG. 5C is similar to the configuration of the illumination module 100B in FIG. 5B, and a main difference therebetween is that a collimating assembly 120C of the illumination module 100C further comprises a tunable lens based beam expander consisting of a pair of offset lenses 124 and 127 and a pair of electronically controlled focal length tunable lenses 125 and 126, instead of the Galilean beam expander consisting of the diverging lens 122 and the converging lens 123 as shown in FIG. 5B. Either one or both of the electronically controlled focal length tunable lenses 125 and 126, thereafter referred to as tunable lens, are controlled by controller 12. Similar to the embodiment shown in FIG. 5B, the addition of the tunable lens based beam expander is mainly for adjusting the diameter of the light beam L, and the relative distances z1, z2 and z3 between the first axicon 131, the relay lens 132, the second axicon 133, and the back focal plane of the objective lens 300 may remain the same as in the embodiment shown in FIG. 5A. Compared to the beam expender illustrated in FIG. 5B, the tunable lens based beam expander could further allow a dynamic or automatic control of the diameter of the light beam.

A configuration of an illumination module 100D according to an exemplary embodiment (e.g., a fourth embodiment of the illumination module) of the disclosure will now be described with reference to FIG. 6A. The configuration of the illumination module 100D in FIG. 6A is similar to the configuration of the illumination module 100A in FIG. 5A, and a main difference therebetween is that a beam shaping optical assembly 130D of the illumination module 100D includes a first aperture filter 134 and a second aperture filter 135 instead of the first axicon 131 and the second axicon 133. The aperture filters may be characterized by an obstruction diameter and a pinhole diameter. The obstruction diameter may range from 50 μm to 500 μm and the pinhole diameter may range from 50 μm to 1000μm; other specifications may be suitable for the purpose of the present disclosure. The first aperture filter 134 and the second aperture filter 135 may have identical or different annular slit configurations. FIG. 6B is a schematic plan view illustrating an annular slit of an aperture filter of FIG. 6A according to an exemplary embodiment of the disclosure. Referring to FIG. 6B, the first aperture filter 134 and the second aperture filter 135 may respectively be a ring mask, but the disclosure is not limited thereto. In the embodiment shown in FIG. 6A, relative distances z1, z2 and z3 between the first aperture filter 134, the relay lens 132, the second aperture filter 135, and the back focal plane of the objective lens 300 may be the same as the relative distances z1, z2 and z3 between the first axicon 131, the relay lens 132, the second axicon 133, and the back focal plane of the objective lens 300 in the embodiment shown in FIG. 5A.

A configuration of an illumination module 100E according to a fifth exemplary embodiment of the disclosure will now be described with reference to FIG. 7. The configuration of the illumination module 100E in FIG. 7 is similar to the configuration of the illumination module 100A in FIG. 5A and the configuration of the illumination module 100D in FIG. 6A, and a main difference lies in that the beam shaping optical assembly 130E of the illumination module 100E is a Spatial Light Modulator (SLM). The SLM uses a phase hologram to recreate the diffraction phenomena obtained by the axicons of the beam shaping optical assembly 130D in FIG. 5A to 5C and FIG. 6. However, it could be noted that a light throughput obtained with the beam shaping optical assembly 130E adopting the SLM and the beam shaping optical assembly 130D adopting the aperture filters may be smaller than that obtained with the beam shaping optical assembly 130 adopting the axicons.

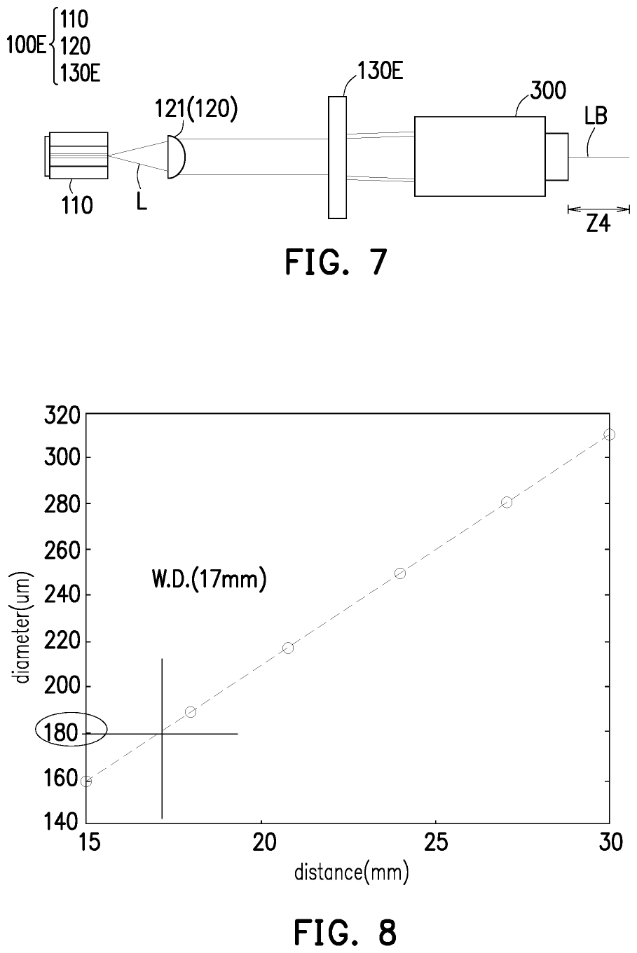

FIG. 8 is a graph illustrating a relationship between a working distance of an objective lens and a diameter of the illumination beam according to an exemplary embodiment of the disclosure. In FIG. 8, a curve representing the relationship between the working distance of the objective lens 300 and the diameter Dlb of the illumination beam LB is obtained through simulations based on the optical design illustrated in FIG. 5A with the 2 axicons 131 and 133 having a physical angle of 0.5° and the lens 132 having a focal length of 120 mm. Given an objective lens working distance, the curve allows the design, selection, dimensioning and parametrization of the beam shaping optical elements in order to fit particular hole characteristics. For an example, when the working distance (W.D.) of the objective lens 300 is 17 mm, the diameter Dlb of the illumination beam LB suitable for performing the depth measurement will be determined to be 180 μm, which is suitable for a hole with a diameter Dh of 400 μm.

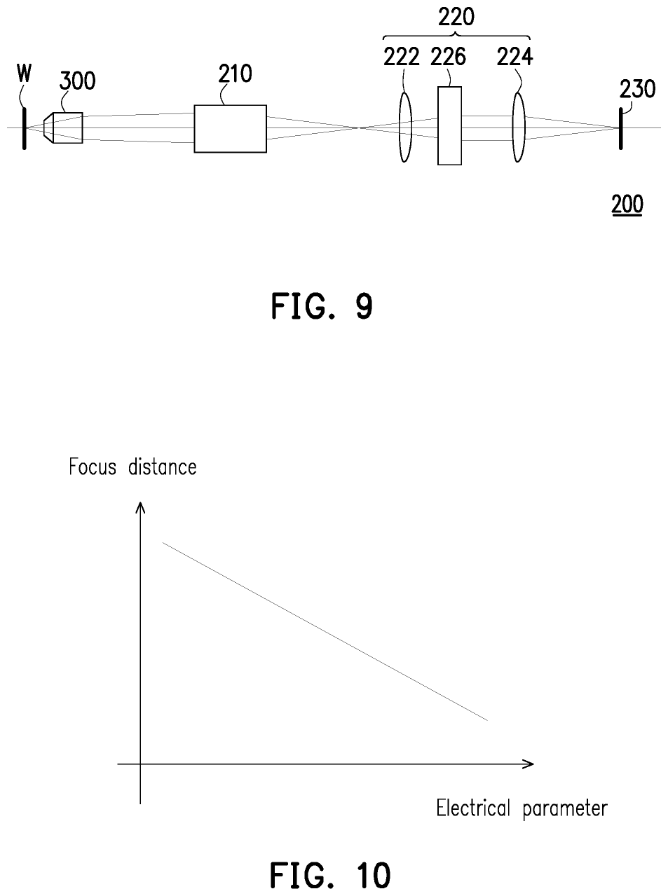

FIG. 9 is a schematic diagram of an image capture module that could be used in an exemplary embodiment of the disclosure. For the convenience of explanation, components relevant to the generation of images (that is, components on an image path of the optical system 10) are illustrated without the beam splitter 400 since it does not participate to image formation and only contributes to light absorption or polarization. The objective lens 300, the tube lens 210, the tunable lens assembly 220, and the image sensor 230 are sequentially disposed on an imaging path of the optical system 10. In the embodiment, the tunable lens assembly 220 may include an electronically controlled focal length tunable lens 226 and two relay lenses 222 and 224, wherein the electronically controlled focal length tunable lens 226, thereafter referred to as tunable lens 226, is disposed between the two relay lenses 222 and 224, the tube lens 210 is disposed between the objective lens 300 and the relay lens 222, and the relay lens 224 is disposed between the focal length of the tunable lens 226 and an imaging plane of the image sensor 230. This disposition positions the tunable lens at a conjugate plane of the back focal plane of the objective lens, thereby leading to a minimal variation of the magnification ratio of the image capture module. Such disposition essentially constitutes a telecentric optical system. The focal length of the tunable lens 226 is controlled by changing the value of an electrical parameter (e.g. a voltage or a current). For example, the tunable lens 226 includes a liquid lens or a liquid crystal lens, and the image sensor 230 includes a charge-coupled device (CCD) or a complementary metal-oxide semiconductor (CMOS), but the disclosure is not limited thereto.

Referring back to FIG. 1, in the depth measurement apparatus 1 of the disclosure, the controller 12 may, for example, be a hardware controller or a control system capable of controlling the illumination module 100, the image capture module 200 and the translation stage 16. In one embodiment, the controller 12 may be configured to control the intensity of the light source 110, the focal length of the tunable lens 226 and the position of the translation stage 16. The processor 14 is configured to obtain images captured by the image sensor 230 of the image capture module 200 and perform image processing on the captured images, and the processor 14 is also configured to perform a calibration of the image capture module 200. The processor 14 may further include a memory for storing the results of image processing, calibration results, data information, control parameters and other pieces of data necessary or relevant to the operation of the disclosure. The memory may be integrated in the processor 14 or be a separate storage device electrically connected to the processor 14, and the disclosure is not limited thereto. In one embodiment, the processor 14 may be built in the image capture module 200 or built in a mobile device, a gateway, or a cloud system, but the disclosure is not limited thereto.

FIG. 10 is a graph illustrating a relationship between an electrical parameter applied to the electronically controlled focal length tunable lens and a focus distance of the image capture module of FIG. 9 according to an exemplary embodiment of the disclosure. This relationship is obtained by means of a calibration of the image capture module 200 performed by the processor 14, the controller 12 and the translation stage 16, and is detailed thereafter. Using the calibration, the processor 14 assesses in-focused pixels in the images captured by the image capture module 200 when a given electrical parameter is applied to the tunable lens 226 in order to determine a height difference between, for example, the top surface 21a (as shown in FIG. 3A) and the layer 22 of the object OBJ (20a) or between the top surface 21b of the object OBJ (20b) and the bottom surface 23 of the hole (as shown in FIG. 3B), so as to obtain the depth Zh (Zha or Zhb) of the hole. The calibration performed on the image capture module 200 may include means to vary the distance between a calibration target and the objective lens 300. For example, a Ronchi ruling calibration target may be positioned on the translation stage 16 under the objective lens 300, and by varying the location of the target in a Z-axis direction along the optical axis of the image capture module 200, the distance between the calibration target and the objective lens 300 may be changed.

For example, the translation stage 16 is firstly positioned in such a way that the when the smallest electrical parameter is applied to the tunable lens 226, the focus distance of the image capture module 200 is the longest, and the focus is assessed by the processor 14 by, for example, evaluating the sharpness of pixels in the captured image. Next, the translation stage 16 performs a translation along a Z-axis direction so as to reduce the distance between the calibration target and the objective lens 300, the processor 14 assesses the focus in the captured image, and the electrical parameter applied to the tunable lens 226 is increased until the image captured is in focus. The same steps are repeated over the range of electrical parameters of the tunable lens 226 so as to obtain a calibration curve such as the one illustrated on FIG. 10. The relationship between the electrical parameter and the focus distance of the tunable lens 226 may depend on the temperature of the tunable lens 226; and therefore, the focus variation curve could be established at a given temperature and the depth measurement could be performed at the same temperature. Accordingly, the calibration of the image capture module 200 could be performed routinely and at different inspection temperature conditions, and results of the calibration could be stored in the memory of the processor 14 as a Look Up Table (LUT) or as predetermined focus variation curves associating known focus distances with known electrical parameters applied to the tunable lens 226 under different inspection temperature conditions. The LUT or the predetermined focus variation curves may be used to perform focus distance evaluation on the images captured by the image capture module 200 so as to determine a height (or depth) difference between the top surface 21a and the interface 22 of the object OBJ (20a) or between the top surface 21b of the object OBJ (20b) and the bottom surface 23 of the hole, thereby obtaining the depth Zh (Zha or Zhb) of the hole.

Referring back to FIG. 1 and FIG. 2, in the embodiment, the depth measurement apparatus 1 is adapted to measure the depth Zh of the hole formed in the object OBJ by illuminating the hole with the illumination beam LB generated by the illumination module 100 and assessing in-focused pixels in the images captured by the image capturing module 200 so as to determine a height difference between a highest and a lowest surfaces of the hole, wherein the highest surface of the hole is at the top surface 21 (21a or 21b) of the object OBJ, the lowest surface of the hole is at the interface 22 of the object OBJ or being the bottom surface 23 of the hole, and the height (or depth) difference denotes the depth Zh (Zha or Zhb) of the hole; it could be noted that a height difference between any surface of an object may also be obtained using the disclosure.

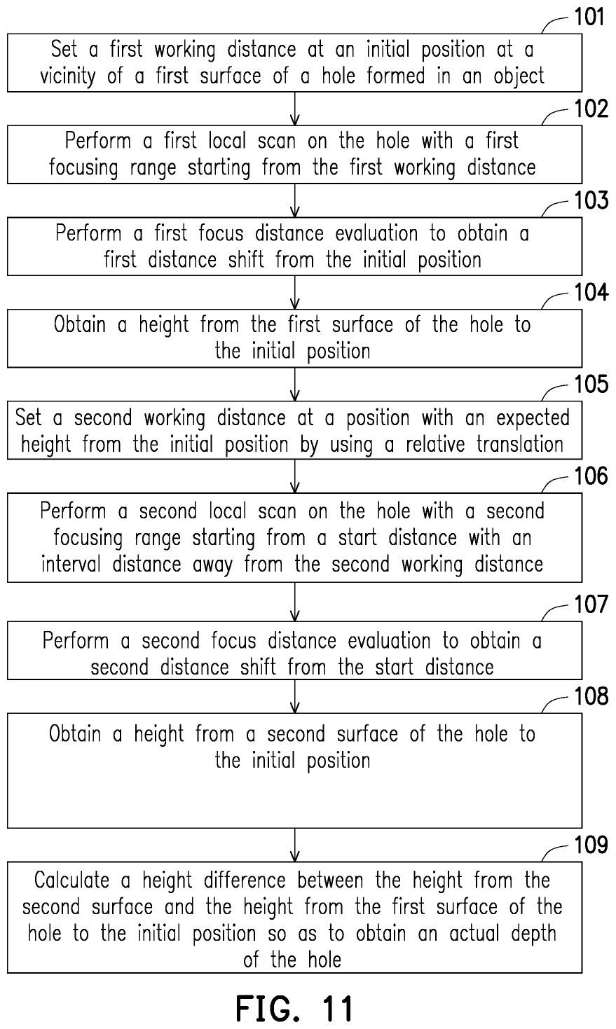

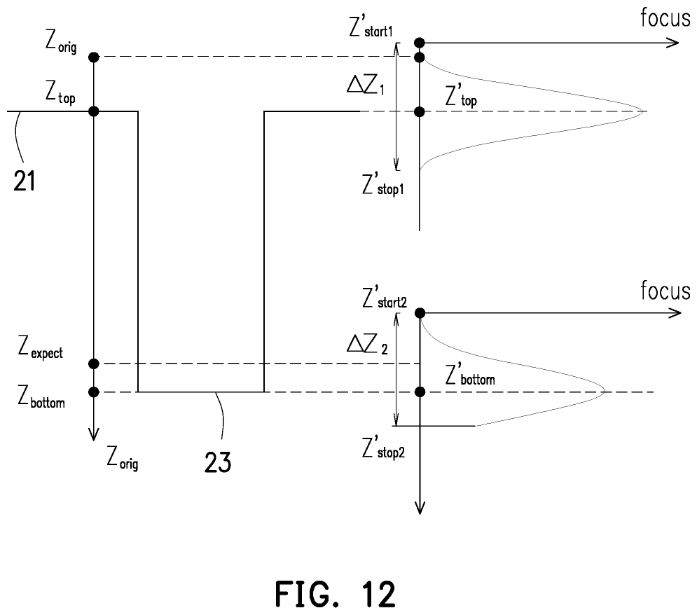

FIG. 11 is a flow chart of a depth measurement method according to an exemplary embodiment of the disclosure. FIG. 12 is a schematic diagram showing steps for measuring a depth of a high aspect ratio hole according to an exemplary implementation of the depth measurement method. The embodiments shown in FIG. 11 and FIG. 12 take a blind hole (as shown in FIG. 3B) as an example for the convenience of explanation, but the type of the hole to be measured is not limited thereto. The depth measurement method of the disclosure may also be applied to a through hole (as shown in FIG. 3A) or any structure presenting a height difference.

In the embodiment, the object OBJ having the hole to be measured is disposed on the translation stage 16 and under the image capture module 200, wherein the object OBJ is positioned such that an opening of the hole faces toward the objective lens 300 and the top surface 21 of the hole is close to the smallest focal distance of the imaging capture module 200 so that the illumination beam LB generated by the illumination module 100 could illuminate the bottom of the hole.

Referring to FIG. 11 and FIG. 12, in step 101, a first working distance of the image capture module 200 is set at an initial position Z_{orig} which is at a vicinity of or above a first surface (e.g., the top surface 21) of the hole and approximates the smallest focal distance of the imaging capture module 200. In step 102 of FIG. 11, the image capture module 200 performs a first local scan on the hole with a first focusing range ΔZ₁ starting from a distance Z′ₛₜₐᵣₜ₁ and a distance Z′ₛₜₒₚ₁ so as to capture a first set of images, wherein the distance Z′ₛₜₐᵣₜ₁ is defined as a distance from the initial position Z_{ong} to the objective lens 300 and is the first working distance.

In step 103 of FIG. 11, a focus distance evaluation is performed on the first set of images captured by the image capture module 200 to obtain a distance shift Z′ₜₒₚ from the initial position Z_{orig} corresponding to the distance Z′ₛₜₐᵣₜ₁, wherein the distance shift Z′ₜₒₚ is defined as a distance variation between the distance Z′ₛₜₐᵣₜ₁ and a location of a focus peak within the first focusing range ΔZ₁, and the location of the focus peak is determined based on a focus distance at which an image containing maximum in-focus pixels is captured. Specifically, in the embodiment, in-focused pixels in each of the first set of images are obtained, electrical parameters at which the first set of images are respectively captured are determined, and focus distance variation between in-focus pixels in different images of the first set of images could be derived from the electrical parameter variation corresponding to the first set of images. In the embodiment, the in-focused pixels in each of the first set of images may be obtained by performing a subpixel edge detection, a blur detection, a bilateral filtering, or other edge detection techniques, but the disclosure is not limited thereto. Moreover, in the embodiment, the focus distance corresponding to each of the first set of images captured by the image capture module 200 may be determined by referencing to the LUT, or be calculated according to the focus variation curve, which is may be obtained according to the calibration of the image capture module 200 which steps were described earlier.

In an alternative embodiment, the focus distance evaluation may also be performed by adopting an auto-focusing technique to find the image containing the maximum in-focus pixels within the first focusing range ΔZ₁ of the image capture module 200, and the first local scan may be stopped immediately after the distance shift Z′ₜₒₚ is obtained.

Next, in step 104 of FIG. 11, a height Zₜₒₚ from the first surface (e.g., top surface 21) of the hole to the initial position Z_{orig} may be obtained. Specifically, the height Zₜₒₚ from the first surface (e.g., the top surface 21) of the hole to the initial position Z_{orig} may be obtained by determining the distance shift Z′ₜₒₚ from the distance Z′ₛₜₐᵣₜ₁.

Further, in step 105 of FIG. 11, a second working distance of the image capture module 200 is set according to an expected depth d_{expect} of the hole and the height Zₜₒₚ from the first surface (e.g., the top surface 21) of the hole to the initial position Z_{orig}, wherein the second working distance is set at a position with an expected height Z_{expect} from the initial position Z_{orig}, and the expected height Z_{expect} could be calculated by: Z_{expect}=Zₜₒₚ+d_{expect}.

As shown in FIG. 12, the working distance of the image capture module 200 is shifted from the first working distance corresponding to the initial position Z_{orig} to the second working distance corresponding the expected height Z_{expect} from the initial position Z_{orig}. In the embodiment, shifting of the working distance of the image capture module 200 is achieved by varying the electrical parameters applied to the tunable lens so as to vary its focal length. In other embodiments, a physical distance between the object and objective lens may be varied using translation stage 16 or a combination of varying the physical distance between the object and objective lens and varying the focal length of the tunable lens.

Next, in step 106 of FIG. 11, the image capture module 200 performs a second local scan on the hole with a second focusing range ΔZ₂ starting from a distance Z′ₛₜₐᵣₜ₂ to a distance Z′ₛₜₒₚ₂ so as to capture a second set of images, wherein the distances Z′ₛₜₐᵣₜ₂ and Z′ₛₜₒₚ₂ are respectively set at interval distances of ±ΔZ₂/2 away from the second working distance such that the second working distance is a median of the second focusing range ΔZ₂.

In step 107 of FIG. 11, the focus distance evaluation is also performed on the second set of images captured by the image capture module 200 to obtain a distance shift Z′_{bottom} from the distance Z′ₛₜₐᵣₜ₂, wherein the distance shift Z′_{bottom} is defined as a distance variation between the distance Z′ₛₜₐᵣₜ₂ and a location of a focus peak within the second focusing range ΔZ₂. In the embodiment, the focus distance evaluation is performed after all the second set of images are captured over the second local scan. However, in an alternative embodiment, the focus distance evaluation may be performed by adopting an auto-focusing technique to find the image containing the maximum in-focus pixels within the second focusing range ΔZ₂ of the image capture module 200, and the second local scan may be stopped immediately after the distance shift Z′_{bottom} is obtained.

Next, in step 108 of FIG. 11, a height Z_{bottom} from a second surface (e.g., the bottom surface 23) of the hole to the initial position Z_{orig} may be obtained based on the following equation: Z_{bottom} the height Z_{bottom}=Z_{expect}−(ΔZ₂/2)+Z′_{bottom}. Specifically, from the second surface (e.g., the bottom surface 23) of the hole to the initial position Z_{orig} may be calculated based on the expected height Z_{expect} from the initial position Z_{orig}, the second focusing range ΔZ₂ and the distance shift Z′_{bottom} from the distance Z′ₛₜₐᵣₜ₂.

Finally, in step 109 of FIG. 11, a height difference between the height Z_{bottom} and the height Zₜₒₚ is calculated so as to obtain an actual depth Zh of the hole formed in the object OBJ.

It could be noted that the distance values, the focusing range values and the height values are provided in the example mentioned in the steps 104, 105, 108 and 109 above for explanation purpose only and could not be taken as boundaries or limitations of actual measurement parameters. The first and second working distances of the image capture module 200 and the first and second focusing ranges for capturing the images may be set or selected according to actual requirements, and the disclosure is not intended to limit the first and second working distances and the first and second focusing ranges of the image capture module 200. In addition, the first focusing range and the second focusing range may be the same or different from each other based on the actual requirements.

In summary, in the embodiments of the disclosure, an illumination beam capable of illuminating the bottom of a high aspect ratio hole formed in an object without illuminating a top surface of the object is generated. Images of the high aspect ratio hole are captured within two focusing distance ranges respectively set at vicinities of a top and a bottom surfaces of the high aspect ratio hole (or the top surface of the object and an expected interface location) so as to obtain a height difference between the top surface (e.g., highest surface) and the bottom surface (e.g., lowest surface) of the high aspect ratio hole. Therefore, the depth measurement apparatus and the depth measurement method of the discourse are able to obtain an actual depth of the high aspect ratio hole without causing back reflected signals or reflected parasitic signals. Moreover, the depth measurement apparatus and the depth measurement method of the discourse could be adopted to obtain depth measurements of any concave or convex structure.

It will be apparent to those skilled in the art that various modifications and variations could be made to the structure of the disclosed embodiments without departing from the scope or spirit of the disclosure. In view of the foregoing, it is intended that the disclosure covers modifications and variations of this disclosure providing they fall within the scope of the following claims and their equivalents.

What is claimed is:

1. A depth measurement apparatus, comprising:
an illumination module, comprising a light source, a collimating assembly and a beam shaping optical assembly, and configured to generate an illumination beam;
a beam splitter, disposed on an optical path of the illumination beam;
an objective lens, disposed on the optical path of the illumination beam and configured to generate a non-diffracting beam from the illumination beam and illuminate a hole formed in an object with the non-diffracting beam;
an image capture module, comprising the objective lens, a tube lens, a tunable lens assembly and an image sensor, and configured to capture images of the hole at different heights;
a controller, coupled to the illumination module and the image capture module, wherein the controller is configured to control the illumination module and the image capture module; and
a processor, coupled to the controller and the image capture module, and configured to perform focus distance evaluations on the images captured by the image capture module in order to obtain a height difference between two surfaces of the object.

2. The depth measurement apparatus as recited in claim 1, wherein the light source is a coherent light source or a partially coherent light source.

3. The depth measurement apparatus as recited in claim 1, wherein the collimating assembly comprises at least a collimating lens to collimate a light beam generated by the light source.

4. The depth measurement apparatus as recited in claim 3, wherein the collimating assembly further comprises a beam expander, and the beam expander comprises at least one tunable lens.

5. The depth measurement apparatus as recited in claim 1, wherein the beam shaping optical assembly comprises a pair of axicons with a relay lens disposed therebetween, a pair of aperture filters with a relay lens disposed therebetween, or a spatial light modulator.

6. The depth measurement apparatus as recited in claim 5, wherein the pair of axicons comprises a first axicon and a second axicon, and relative distances between the first axicon, the relay lens, the second axicon, and a back focal plane of the objective lens are adjustable to vary at least a depth of focus and a diameter of the illumination beam.

7. The depth measurement apparatus as recited in claim 1, wherein a maximum diameter of the illumination beam is smaller than or equal to a smallest dimension of the hole over a length or a depth of the hole.

8. The depth measurement apparatus as recited in claim 1, wherein the objective lens, the tube lens, the tunable lens assembly and the image sensor are disposed on an optical path of a light beam reflected by the object and transmitted through the objective lens so as to constitute a telecentric optical system.

9. The depth measurement apparatus as recited in claim 8, wherein the tunable lens assembly comprises an electronically controlled focal length tunable lens and two relay lenses, the electronically controlled focal length tunable lens is disposed between the two relay lenses, and a focal length of the electronically controlled focal length tunable lens is controlled by changing a value of an electrical parameter applied to the electronically controlled focal length tunable lens.

10. The depth measurement apparatus as recited in claim 1, wherein the beam splitter is a polarizing beam splitter and further comprises a quarter wave plate.

11. The depth measurement apparatus as recited in claim 1, further comprising a translation stage coupled to the controller, and the object is adapted to be disposed on the translation stage during the depth measurement.

12. The depth measurement apparatus as recited in claim 1, wherein the processor is further configured to perform a calibration of the image capture module.

13. The depth measurement apparatus as recited in claim 12, wherein the processor further comprises a memory for storing processing results and/or calibration results generated by the processor.

14. A depth measurement method, using the depth measurement apparatus as recited in claim 1, the depth measurement method comprising steps of:
setting a first working distance at an initial position at a vicinity of a first surface of a hole formed in an object;
performing a first local scan on the hole with a first focusing range starting from the first working distance;
performing a first focus distance evaluation to obtain a first distance shift from the initial position;
obtaining a height from the first surface of the hole to the initial position;
setting a second working distance at a position with an expected height from the initial position by using a relative translation;
performing a second local scan on the hole with a second focusing range starting from a start distance with an interval distance away from the second working distance;
performing a second focus distance evaluation to obtain a second distance shift from the start distance;
obtaining a height from a second surface of the hole to the initial position; and
calculating a height difference between the height from the second surface and the height from the first surface of the hole to the initial position so as to obtain an actual depth of the hole.

15. The depth measurement method as recited in claim 14, wherein the first working distance approximates a smallest focus distance of the imaging capture module, and the start distance is smaller than the second working distance.

16. The depth measurement method as recited in claim 14, wherein the position for setting the second working distance is determined according to an expected depth of the hole and the height from the first surface of the hole to the initial position, and the step of setting the second working distance at the position with the expected height from the initial position by using the relative translation comprises:
shifting a working distance of the image capture module from the first working distance corresponding to the initial position to the second working distance corresponding the expected height from the initial position by performing a relative translation between the object and the objective lens in a Z-axis direction.

17. The depth measurement method as recited in claim 14, wherein the first distance shift from the initial position is obtained based on a distance variation between the first working distance and a location of a focus peak within the first focusing range, and the second distance shift from the start distance is obtained based on a distance variation between the start distance and a location of a focus peak within the second focusing range.

18. The depth measurement method as recited in claim 17, wherein the first and second focus distance evaluation are performed by obtaining in-focused pixels in each of a plurality of images captured by the image capture module, relating the images with the in-focused pixels to electrical parameters at which the images are respectively captured, and determining focus distance variations between the in-focus pixels in different images of the images captured by referencing to a pre-established Look Up Table or predetermined focus variation curves stored in a memory of the processor.

19. The depth measurement method as recited in claim 14, wherein the height from the second surface of the hole to the initial position is obtained by using the expected height from the initial position, the interval distance and the second distance shift from the start distance.
